(19) United States
(12) Patent Application Publication
(10) Pub. No.: US 2004/0074122 A1
(43) Pub. Date: Apr. 22, 2004

(54) Permit driver/young driver warning apparatus

(76) Inventors: Julie A. Goodwin, Galesburg, MI (US); Dennis Goodwin, Galesburg, MI (US)

Correspondence Address: Richard C. Litman, LITMAN LAW OFFICES, LTD., P.O. Box 15035, Arlington, VA, 22215, US

(21) Appl. No.: 10/273,156

(22) Filed: Oct. 18, 2002

(51) Int. Cl. G09F 21/04

(52) U.S. Cl. 40/592

(57) ABSTRACT

A permit driver/young driver warning device comprising a reflective sign mountable on a vehicle roof to warn other drivers that a beginner driver driving the vehicle pursuant to a learner's permit only is driving the vehicle. The trapezoidal warning sign can take several geometric forms, such as having two to four extensive planar sides, and is removably attachable to the roof of the vehicle. Illumination on two or four sides inside the device can be provided by either incandescent lamps, fluorescent lamps, light emitting diodes, and mixtures thereof.

### BACKGROUND OF THE INVENTION

1. Field of the Invention

The present invention relates generally to safety devices for vehicles. More specifically, the invention is a sign mountable on the roof of a car for making other drivers aware that the driver of the car is a young driver driving under a permit status, and who therefore may not have a certified driver education instructor present in the vehicle.

2. Description of the Related Art

The related art of interest describes various warning signs for vehicles and the like, but none discloses the present invention. There is a need in this crowded art for a removable large sign for placing on top of a vehicle driven by a young beginner driver to warn other drivers of the inexperienced driver. The related art will be discussed in the order of perceived relevance to the present invention.

U.S. Design Pat. No. 326,282 issued on May 19, 1992, to Eugene Y. Mori describes an ornamental display sign for automobile windows, presumably for the rear window, comprising an elongated container having a slot for inserting signs such as “DRIVE SAFELY” and “HANDICAPPED” in the large opening in the front. The rear side has a smaller slot opening. The ends are truncated triangles. The ornamental sign is distinguishable for being limited to the interior surface of vehicle windows.

U.S. Design Pat. No. 433,457 issued on Nov. 7, 2000, to Cynthia L. Linton describes an ornamental vehicle safety sign with “STUDENT DRIVER” held by suction cups on the driver's side on the side of the vehicle. The ornamental sign is distinguishable for being required to be posted on the driver's side on the outside of the vehicle.

U.S. Design Pat. No. 448,808 issued on Oct. 2, 2001, to Ronald L. Oswick et al. describes an ornamental mobile billboard comprising a rectangular billboard with an off-centered rectangular opening with four apertured lugs to presumably hold a license plate. A second embodiment centers the rectangular opening. The ornamental billboard is distinguishable for presumably replacing a vehicle license plate holder.

U.S. Design Pat. No. 304,737 issued on Nov. 21, 1989, to Eugene Y. Mori describes an ornamental sign for an automobile window with the words “INFANT INSIDE” and suction cups on the same side and at the ends. The ornamental sign is distinguishable for being required to be placed inside the vehicle on a window.

U.S. Design Pat. No. 398,409 issued on Sep. 15, 1998, to Anis Jessa describes an ornamental illuminated cab sign presumably for the top of a taxi cab. The sign is trapezoidal in shape and triangular in cross-section with open glass portions on the long sides and at the ends. The bottom surface is curved to fit the vehicle roof. The ornamental sign is distinguishable for requiring multiple open glass portions.

U.S. Pat, No. 447,774 issued on Sep. 11, 2001, to William A. Elmer et al. describes an ornamental advertising sign for vehicles comprising a triangular shape with semicircular projections in front and in the rear. The four corners have smooth projecting feet. The ornamental sign is distinguishable for its unique shape.

U.S. Design Pat. No. 326,282 issued on May 19, 1992, to Davor Spoljaric describes an ornamental vehicle message display sign comprising an illuminated rectangular sign having numbers, and with angular ends having three faces. The ornamental signs are distinguishable for requiring the specific angular shape.

U.S. Design Pat. No. 327,506 issued on Jun. 30, 1992, to Gunther Bartholomai et al. describes a taxi cab's roof sign comprising “TAXI” on front and rear sides thereof, having a cross-section with the front side inclined 45° and the rear side inclined 5°, and a separable bottom section with either an elliptical aperture or an extended elliptical extension bracket on each end. Presumably, the sign is bolted to the roof. The ornamental sign is distinguishable for being limited to the identification of a commercial vehicle.

U.S. Design Pat. No. 328,142 issued on Jul. 21, 1992, to Joe Bell et al. describes an ornamental display sign for automobiles or the like with a recessed rectangular glass window encased in front of a trapezoidal housing with sloping sides and lower side corner depressions, a blank rear wall, illuminated by electricity, and four apertured lugs for attachment to the vehicle, presumably for attachment to the rear window. The ornamental sign is distinguishable for requiring only one sign in the front of the device.

U.S. Design Pat. No. 336,662 issued on Jun. 22, 1993, to Linda S. Smith et al. describes an ornamental rectangular illuminated sign for vehicles and for installation on an exterior flat side or rear surface. The sign has an upper flap for attachment by four fasteners, an upper front portion of the housing having three spaced reflectors, a lower front portion of the housing containing 6 light bulbs illuminating “THANKS”, two rectangular attachment plates with four apertures each in line with the housing and the upper flap, two hooded lamps at the juncture of the housing and the plate, and a top-hinged rear cover. The ornamental sign is distinguishable for requiring numerous lamps and reflectors.

U.S. Design Pat. No. 344,101 issued on Feb. 8, 1944, to Angelo DeRaffele et al. describes an illuminated emergency sign for automobiles comprising a rectangular housing having light emitting diodes (LEDs) illuminating “HELP” signs in front and in the rear, presumably two square magnets on the bottom, and a cigarette lighter plug and extension. The ornamental sign is distinguishable for requiring magnetic attachment means and illumination by the vehicle.

U.S. Design Pat. No. 374,191 issued on Oct. 1, 1996, to Sheila Terrebonne et al. describes an ornamental courtesy signal light comprising a housing having an inclined glass pane inset in front with a “THANK YOU” sign and directional arrows on either side of the indicia. The right and left sides of the housing are flat and inclined. The illumination source is unknown to illuminate the presumed LED diodes of the sign. The opaque rear side is rounded. The placement of the sign is presumed to be inside the vehicle and on the rear shelf. The ornamental sign is distinguishable for being limited to a “thank you”, and directional arrows in the housing.

U.S. Design Pat. No. 393,285 issued on Apr. 7, 1998, to Cedric Nipper et al. describes an ornamental window medallion apparatus is a circular flat sign panel with a suction cup on top and on the front surface for placement on the inside. The sign is “EXPECTANT MOM ABOARD” which is considered a humorous notice of an occupant in a vehicle. The ornamental medallion is distinguishable for being limited to the inside of a vehicle.

German Patent Application No. DE 1 802 834, published on Jun. 11, 1970, for Hansjurgen Wolany describes a triangular sign mounted either on the front dashboard or on the rear panel and illuminated by the car battery. The signs are distinguishable for being limited to posting inside a vehicle.

German Patent Application No. DE 1 815 253, published on Jun. 25, 1970, for Walter Hahnel describes a triangular sign mountable on the outside of vehicle window by a bracket and energized by the car battery. The indicia can be an SOS, help or a cross. The signs are distinguishable for requiring a bracket extending from a vehicle's window.

None of the above inventions and patents, taken either singly or in combination, is seen to describe the instant invention as claimed. Thus, a permit driver/young driver warning apparatus solving the aforementioned problems is desired.

### SUMMARY OF THE INVENTION

The present invention is directed to a warning device attachable to a vehicle for warning other drivers that the driver of the vehicle is not a licensed driver, but is a young driver driving by virtue of a learner's permit. The warning device is a sign with indicia designating “TEEN PERMIT DRIVER” encircled by a yield sign outline and mounted on top of the vehicle, i.e., on the roof of the vehicle. The warning device is a trapezoidal shaped sign fabricated from a reflective plastic material, and attached by clamps, tie downs, suction cups or magnetic attaching elements for easy removal.

The laws in different jurisdictions relating to the requirements for obtaining, and the privileges granted by, a learner's permit for driving a motor vehicle are often conflicting. In some states the learner must be over sixteen years old, while in others the age may be fifteen and one-half. In some states the holder of a learner's permit must have a licensed driver present in the vehicle at all times, while other jurisdictions may only require a licensed driver to be present while driving at night. A driver enrolled in a driver's education program will often drive a vehicle provided by the program with signage indicating “Student Driver” with a certified driver's education instructor present in the vehicle. However, when using the family vehicle for practicing driving pursuant to the learner's permit, there is no signage on the vehicle to alert other drivers that the vehicle is not being driven by a licensed driver, an often irritating and sometimes dangerous set of circumstances. The present invention addresses the need to alert other drivers of the presence of a young driver who is driving a vehicle pursuant to a learner's permit by a sign which can be removably attached to the vehicle to indicate the status of the driver.

Accordingly, it is a principal object of the invention to provide a warning sign for a vehicle driven by a young driver who is not yet licensed, but driving pursuant to privileges granted by a learner's permit.

It is another object of the invention to provide a warning sign mounted on the top of the driven vehicle by various attachment elements such as clamps, tie downs, suction cups, or magnets.

It is a further object of the invention to provide a warning sign having a trapezoidal shape and a reflective surface.

Still another object of the invention is to provide a warning sign having “TEEN PERMIT DRIVER” on both the front and rear sides.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a permit driver/young driver warning sign mounted on the roof of the driven vehicle according to the present invention.

FIG. 2 is an enlarged perspective view of the warning device.

Similar reference characters denote corresponding features consistently throughout the attached drawings.

### DETAILED DESCRIPTION OF THE PREFERRED EMBODIMENT

The present invention is directed to a permit driver/young driver warning device for mounting on a vehicle roof to alert the general public that a young driver is currently driving the vehicle having a state permit, i.e., a learner's permit. The young driver may or may not be under the guidance of a licensed adult driver. The important benefit is the young driver's safety, because experienced adjacent drivers would be alerted and become more considerate of inexperienced drivers, instead of taking advantage of them. Young unlicenced drivers have voiced their opinion that they would be more confident in driving, because the other experienced drivers become aware of them. The car insurance companies would welcome this device, because the minor traffic accidents arising from young drivers would be decreased. The use of this device would help to diffuse those individuals who suffer from “road rage”, and may become instantly impatient and harass the young driver without this warning device. This device can be used by high schools and driving instruction schools to result in better warning to other drivers and to lessen the number of accidents.

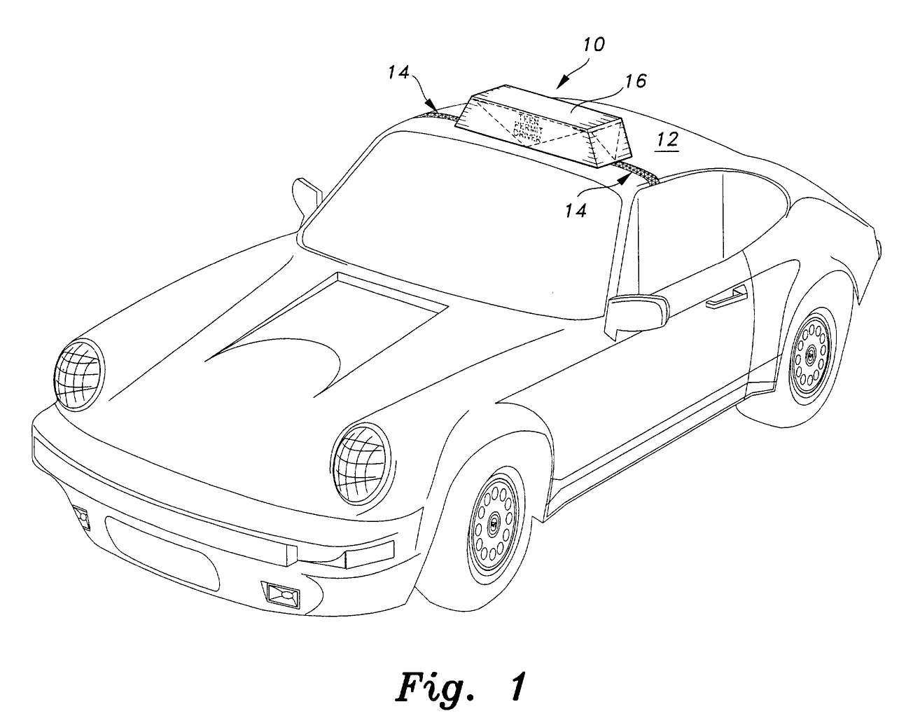

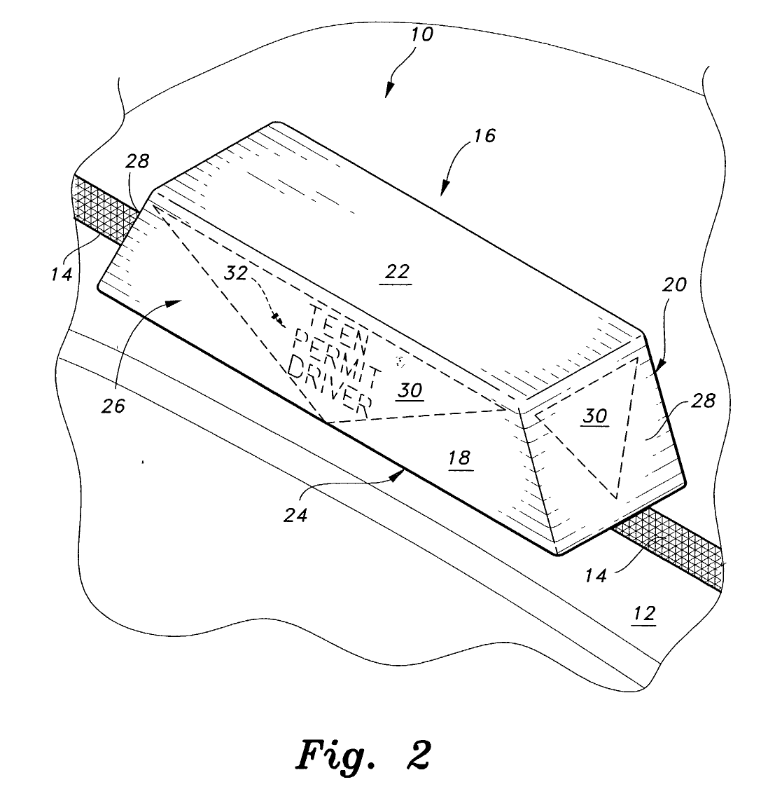

FIGS. 1 and 2 illustrate the position of the permit driver/young driver sign device 10 fastened to the vehicle roof 12 by a tie down fastening strap 14. Other conventional fastening elements can be clamps, suction cups, or magnets for mounting the device 10 on the vehicle roof 12. The fasteners must be reliable for maintaining the device 10 in its position for speeds up to at least 80 miles per hour. Moreover, the fasteners must be capable of being readily disengaged for removing the device 10 from the vehicle roof 12 when no longer necessary.

The housing 16 can be made of a strong reflective plastic material of any light color with indicia printed in a dark, opaque, or contrasting color. The housing 16 is configured with a front planar surface 18, a rear planar surface 20, an optional top planar surface 22, and, depending upon its cross-sectional shape, a bottom planar surface 24. The housing 16 has an overall trapezoidal shape 26 with two sloping sides 28 as viewed from the front or rear, and a number of sides selected from the group consisting of two, three and four. FIGS. 1 and 2 show only a device 10 with four visible sides. Devices with two visible sides would be a planar board (not shown). Devices with three planar visible sides would be a prism with a triangular cross-section (not shown). The top and bottom surfaces 22, 24, need not be reflective, but may be opaque.

Illumination inside the housing 16 is optional with either incandescent lamps, fluorescent lamps or light emitting diodes (LEDs) energized by either an internal battery or by a line cord to the cigarette plug inside the vehicle (not shown).

The device 10 includes indicia of an inverted triangle 30 shown on all four visible sides of the device 10. The triangle 30 is recognizable by drivers as the outline of a “Yield” sign. Within the triangle 30 on only the front and rear sides, 18, 20, is indicia 32 bearing the wording “TEEN PERMIT DRIVER”. As mentioned above, the recognition of the indicia would instantly warn other adjacent drivers that a teen-age driver having a driving permit only is operating the vehicle.

Thus, a highly visible warning sign placed in a visible position on the roof of a vehicle being driven by a teenager driver would alert nearby drivers that caution should be observed. The sign can be readily removed, stored and used when required.

It is to be understood that the present invention is not limited to the embodiment described above, but encompasses any and all embodiments within the scope of the following claims.

We claim:

1. A permit driver/young driver warning device for mounting on a vehicle roof, comprising:
a housing made from reflective plastic material and having a front planar surface, a rear planar surface and a bottom planar surface, and said front and rear planar surfaces having a trapezoidal shape and a number of extensive sides selected from the group consisting of two, three and four, the housing having a warning indicia displayed thereon consisting of “TEEN PERMIT DRIVER” on said front and rear planar surfaces of the housing; and
attachment means on said bottom planar surface for securing the device to the roof of a vehicle;
whereby other drivers in the vicinity of the permit driver/young driver would be readily forewarned of a driver with permit privileges only.

2. The permit driver/young driver warning device according to claim 1, wherein the warning indicia is encircled by an indicia formed as an inverted triangle simulating a traffic yield sign.

3. The permit driver/young driver warning device according to claim 1, wherein the housing is configured with two extensive parallel sides and a uniform thickness.

4. The permit driver/young driver warning device according to claim 3, wherein the housing is configured as a board.

5. The permit driver/young driver warning device according to claim 1, wherein the housing is configured with three extensive sides having a cross-sectional triangular shape.

6. The permit driver/young driver warning device according to claim 5, wherein the housing is configured as a prism having its base attached to the vehicle roof.

7. The permit driver/young driver warning device according to claim 1, wherein the housing is configured with four extensive sides with a cross-sectional trapezoidal shape.

8. The permit driver/young driver warning device according to claim 1, wherein the attachment means is selected from the group consisting of clamps, tie down straps, suction cups, magnets, and mixtures thereof.

9. The permit driver/young driver warning device according to claim 8, wherein the attachment means is a clamp on each side fastened to the window rain gutter.

10. The permit driver/young driver warning device according to claim 8, wherein the attachment means is a tie down strap on each side fastened to a window rain gutter.

11. The permit driver/young driver warning device according to claim 8, wherein the attachment means is a pair of suction cups located at each end of the bottom surface.

12. The permit driver/young driver warning device according to claim 8, wherein the attachment means is a pair of magnets on each end of the bottom surface.

13. The permit driver/young driver warning device according to claim 1, wherein the device is illuminated by a source selected from the group consisting of incandescent lamps, fluorescent lamps, light emitting diodes, and mixtures thereof.

14. The permit driver/young driver warning device according to claim 13, wherein incandescent lamps provide the illumination inside the device.

15. The permit driver/young driver warning device according to claim 13, wherein fluorescent lamps provide the illumination inside the device.

16. The permit driver/young driver warning device according to claim 13, wherein light emitting diodes provide the illumination inside the device.

17. The permit driver/young driver warning device according to claim 13, wherein incandescent lamps and fluorescent lamps provide the illumination inside the device.

18. The permit driver/young driver warning device according to claim 13, wherein fluorescent lamps and light emitting diodes provide the illumination inside the device.

19. The permit driver/young driver warning device according to claim 14, wherein incandescent lamps and light emitting diodes provide the illumination inside the device.
